(19) United States
(12) Patent Application Publication
(10) Pub. No.: US 2006/0041580 A1
(43) Pub. Date: Feb. 23, 2006

(54) Method and system for managing distributed storage

(75) Inventors: Kadir Ozdemir, San Jose, CA (US); Ismail Dalgic, Sunnyvale, CA (US)

Correspondence Address: Edward N. Bachand;DORSEY & WHITNEY LLP, Suite 3400, 4 Embarcadero Center, San Francisco, CA, 94111, US

(73) Assignee: INTRANSA, INC.

(21) Appl. No.: 11/178,122

(22) Filed: Jul. 8, 2005

Related U.S. Application Data
(60) Provisional application No. 60/586,516, filed on Jul. 9, 2004.

(51) Int. Cl. G06F 7/00; G06F 17/00

(52) U.S. Cl. 707/102

(57) ABSTRACT

Embodiments of the present invention provide storage management system and method for managing a geographically distributed storage. In one embodiment, the system includes a plurality of sites organized in a tree form and a management module associated with each site. The plurality of sites include a plurality of management sites each having a network of nodes and storage devices, and at least one parent site having a plurality of virtual nodes corresponding to the plurality of sites. The management module for each site includes a site manager component, a storage resource manager component, and a node manager component.

### CROSS REFERENCE TO RELATED APPLICATION

The present application claims priority to U.S. Provisional Application Ser. No. 60/586,516 entitled “Geographically Distributed Storage Management,” filed on Jul. 9, 2004, which is incorporated herein by reference in its entirety.

### FIELD OF THE INVENTION

The present invention relates in general to storage networks, and more particularly to the management of a distributed storage network.

### BACKGROUND OF THE INVENTION

A storage network provides connectivity between servers and shared storage and helps enterprises to share, consolidate, and manage data and resources. Unlike direct attached storage (DAS), which is connected to a particular server, storage networks allow a storage device to be accessed by multiple servers, multiple operating systems, and/or multiple clients. The performance of a storage network thus depends very much on its interconnect technology, architecture, infrastructure, and management.

Fibre Channel has been a dominant infrastructure for storage area networks (SAN), especially in mid-range and enterprise end user environments. Fibre Channel SANs uses a dedicated high-speed network and the Small Computer System Interface (SCSI) based protocol to connect various storage resources. The Fibre Channel protocol and interconnect technology provide high performance transfers of block data within an enterprise or over distances of, for example, up to about 10 kilometers.

Network attached storage (NAS) connects directly to a local area network (LAN) or a wide area network (WAN). Unlike storage area networks, network attached storage transfers data in file format and can attach directly to an internet protocol (IP) network. Internet SCSI (iSCSI) is an Internet Engineering Task Force (IETF) standard developed to enable transmission of SCSI block commands over the existing IP network by using the TCP/IP protocol. An IP SAN is a network of computers and storage devices that are IP addressable and communicate using the iSCSI protocol. An IP SAN allows block-based storage to be delivered over an existing IP network without installing a separate Fibre Channel network.

To date, most storage networks utilize storage virtualization implemented on a host, in storage controllers, or in other places of the networks. As the storage networks grow in size, complexity, and geographic expansion, a need arises to effectively manage physical and virtual entities in distributed storage networks.

### SUMMARY

Embodiments of the present invention provide systems and methods for managing a geographically distributed storage. In one embodiment, the system includes a network of nodes and storage devices, and a management module for managing the network of nodes and storage devices. The storage devices may be heterogeneous in their access protocols, including, but not limited to, Fibre Channel, iSCSI (internet-SCSI), Network File System (NFS), and Common Internet File System (CIFS).

In one example, the management module includes a Site Manager, a Storage Resource Manager, a Node Manager, and a Data Service Manager. The Site Manager is the management entry point for site administration. It may run management user interfaces such as a Command Line Interface (CLI) or a Graphical User Interface (GUI), manages and persistently stores site and user level information, and provides authentication and access control, and other site-level services such as alert and log management. The Storage Resource Manager provides storage virtualization so that storage devices can be effectively managed and configured for applications of possibly different types. The Storage Resource Manager may contain policy management functions for automating creation, modification, and deletion of virtualization objects, and determining and maintaining a storage layout. The Node Manager forms a cluster of all the nodes in the site. The Node Manager can also perform load balancing, high availability, and node fault management functions. The Data Service Manager may implement data service objects, and may provide virtualized data access to hosts/clients coupled to the network of nodes and storage devices through data access protocols including, but not limited to, iSCSI, Fibre Channel, NFS, or CIFS.

In one example, the components of the storage management module register with a service discovery entity, and integrate with an enterprise network infrastructure for addressing, naming, authentication, and time synchronization purposes.

In another embodiment of the invention, a system for managing a distributed storage comprises a plurality of sites, and a management module associated with each site. The sites are hierarchically organized with an arbitrary number of levels in a tree form, such that a site can include another site as a virtual node, creating a parent-child relationship between sites. Thus, a flexible, hierarchical administration system is provided through which administrators may manage multiple sites from a single site that is the parent or grandparent of the multiple sites. In one example, the administrator name resolution is hierarchical, such that a system administrator account created on one site is referred to relative to the site's name on the hierarchy.

In one example, a service request directed to a site is served by storage resources that belong to the site. In one embodiment, a site administrator can choose to export some of its storage resources for use by a parent site, relinquishing the control and management of these resources to the parent site. The sites may also use resources from other sites that may be determined by access control lists as specified by the site system administrators.

In another embodiment of the invention, a method is provided for making the Site Manager component highly available by configuring one or more standby instances for each active Site Manager instance. In one example, the active and standby Site Manager instances run on dedicated computers. In another example, active and standby Site Manager instances run on the storage nodes.

In another embodiment of the invention, a flexible alert handling mechanism is provided as part of the Site Manager. In one example, the alert handling mechanism may include a module to set criticality levels for different alert types; a user notification module, the notification module through management agents for alerts at or above a certain criticality; an Email notification module providing alerts at or above a certain criticality, a call-home notification module providing alerts at or above a certain criticality, and a forwarding module providing alerts from a child Site Manager to its parent depending on the root cause and criticality.

### BRIEF DESCRIPTION OF THE DRAWINGS

FIG. 1 is a block diagram of a distributed storage management system in accordance with one embodiment of the present invention.

FIG. 2 is a block diagram of a storage management module in the distributed storage management system in accordance with one embodiment of the present invention.

FIG. 3 is a block diagram of a storage management module for a leaf site in the distributed storage management system in accordance with one embodiment of the present invention.

FIG. 4 is a block diagram of a storage management module for a parent site in the distributed storage management system in accordance with one embodiment of the present invention.

FIG. 5 is a block diagram illustrating an example of the distributed storage management system wherein Site Manager instances run on dedicated hosts in accordance with one embodiment of the present invention.

FIG. 6 is a block diagram illustrating an example of the distributed storage management system wherein Site Manager instances run on nodes in accordance with one embodiment of the present invention.

### DETAILED DESCRIPTION

Embodiments of the present invention provide systems and methods for managing geographically distributed storage devices. These storage devices can be heterogeneous in their access protocols and physical interfaces and may include one or more Fibre Channel storage area networks, one or more Internet-Protocol storage area network (IP SAN), and/or one or more network-attached storage (NAS) devices. Various embodiments of the present invention are described herein.

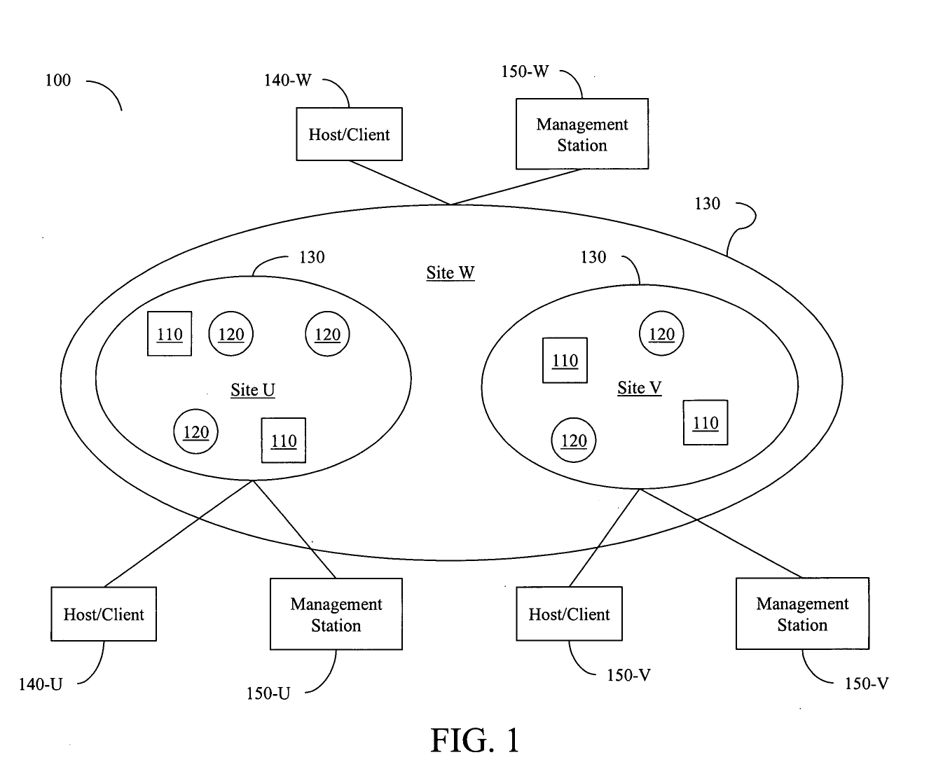

Referring to FIG. 1, a distributed storage network 100 according to one embodiment of the present invention comprises a plurality of storage devices 110, a plurality of nodes 120, and one or more management sites 130, such as sites U, V, and/or W, for managing the plurality of nodes and storage devices. Network 100 further comprises storage service hosts and/or clients 140, such as hosts or clients 140-U, 140-V, and 140-W connected to sites U, V, and W, respectively, and management stations 150, such as management stations 150-U, 150-V, and 150-W associated with sites U, V, and W, respectively. For ease of illustration, the word “client” is sometimes used herein to refer to either a host 140 or a client 140. Although FIG. 1 only shows one host or client 140 and one management station 150 associated with each management site, in reality, there can be a plurality of hosts or clients 140 and a plurality of management stations 150 coupled to a management site 130.

A storage device 110 may include raw or physical storage objects, such as disks, and/or virtualized storage objects, such as volumes and file systems. The storage objects (either virtual or physical) are sometimes referred to herein as storage resources. Each storage device 110 may offer one or more common storage networking protocols, such as iSCSI, Fibre Channel (FC), Network File System (NFS) protocol, or Common Internet File System (CIFS) protocol. Each storage device 110 may connect to the network 100 directly or through a node 120.

A node 120 may be a virtual node or a physical node. An example of a physical node is a controller node corresponding to a physical storage controller, which provides storage services through virtualized storage objects such as volumes and file systems. An example of a virtual node is a node representing multiple physical nodes, such as a site node corresponding to a management site 130, which represents a cluster of all the nodes in the management site, as discussed in more detail below. Depending on whether it serves any locally attached storage devices or not, a node 120 may also be a node without storage or a node with storage. A node 120 without storage has no locally attached storage devices so that its computing resources are used mainly to provide further virtualization services on top of storage objects associated with other nodes, or on top of other storage devices. A node 120 with storage has at least one local storage device, and its computing resources may be used for both virtualization of its own local storage resources and other storage objects associated with other nodes. A node 120 with storage is sometimes referred to as a leaf node.

In one example, storage service clients 140 are offered services through the nodes 120, and not directly through the storage devices 110. In that respect, nodes 120 can be viewed as an intermediary layer between storage clients 140 and storage devices 110.

A management site (“site”) 130 may include a collection of nodes 120 and storage devices 110, which are reachable to each other and have roughly similar geographical distance properties. A site 130 may also include one or more other sites as virtual nodes, as discussed in more detail below. The elements that comprise a site may be specified by system administrators, allowing for a large degree of flexibility. A site 130 may or may not own physical entities such as physical nodes and storage devices. In the example shown in FIG. 1, sites U and V have their own storage resources and physical nodes, and site W only has virtual nodes, such as those corresponding to sites U and V. A site 130 provides storage services to the hosts/clients 140 coupled to the site. The storage services provided by a site include but are not limited to data read/write services using the iSCSI, FC, NFS, and/or CIFS protocols.

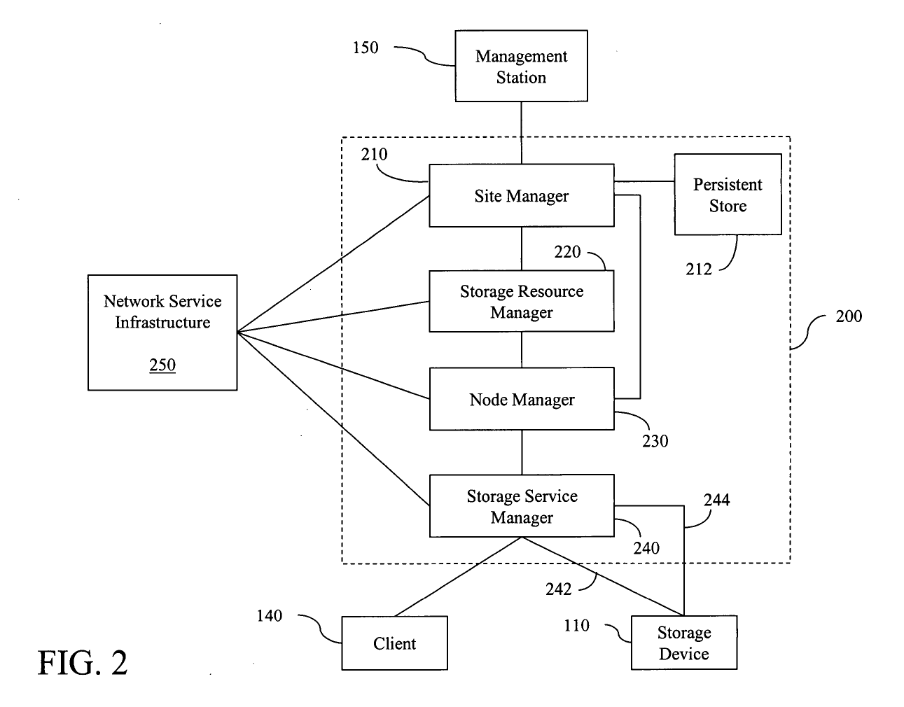

In one embodiment of the present invention, as shown in FIG. 2, the network 100 also includes a storage management module 200 associated with each site 130. The storage management module 200 includes one or more computer parts, such as one or more central processing units and/or one or more memory units or storage media in the network that runs and/or stores a software program or application referred to hereafter as “site software”. In one embodiment, the site software includes a Site Manger portion, a Storage Resource Manager portion, a Node Manager portion, and a Data Service Manager portion. Correspondingly, the storage management module includes one or more hosts 140 coupled to a site and/or on one or more nodes 120 in the site 130 running and/or storing the different portions of the site software. The storage management module 200 may therefore has a Site Manager component 210 in a host 140 or node 120 running and/or storing the Site Management portion of the site software, a Storage Resource Manager component 220 in a host 140 or node 120 running and/or storing the Storage Resource Manager portion of the site software, a Node Manager component 230 in a host 140 or node 120 running and/or storing the Node Manager portion of the site software, and a Data Service Manager component 240 in a host 140 or node 120 running and/or storing the Data Service Manager portion of the site software. The storage management module 200 for a site 130 communicates with the storage devices 110 and nodes 120 in the site, the client(s) 140 and management station(s) 150 coupled to the site, and perhaps one or more other sites 130, to manage and control the entities in the site 130, and to provide storage services to clients 140 coupled to the site.

The storage management module 200 is used by site administrators to manage a site 130 via management station(s) 150, which may run a management user interface, such as a command line interface (CLI) or a graphical user interface (GUI). In one embodiment, the Site Manager 210 is the management entry point for site administration, and the management station 150 communicates via the management user interface with the Site Manager 210 using a site management interface or protocol, such as the Simple Network Management Protocol (SNMP), or Storage Management Initiative Specification (SMI-S). SNMP is a set of standards for managing devices connected to a TCP/IP network. SMI-S is a set of protocols for managing multiple storage appliances from different vendors in a storage area network, as defined by Storage Network Industry Association (SNIA). The Site Manager 210 manages and persistently stores site and user level information, such as site configuration, user names, permissions, membership information, etc. The Site Manager 210 may provide authentication to access a site, and access control rights for storage resources. It can also provide other site-level services such as alert and log management. In one example, at least one active instance of the Site Manager 210 is run for each site 130, as discussed in more detail below.

In one example, the Site Manager 210 is responsible for creating, modifying, and/or deleting user accounts, and handling user authentication requests. It also creates and deletes user groups, and associates users with groups. It is capable of either stand-alone operation, or integrated operation with one or more enterprise user management systems, such as Kerberos, Remote Dial In User Service (RADIUS), Active Directory, and/or Network Information Service (NIS). Kerberos is an IETF standard for providing authentication, RADIUS is an authentication, authorization, and accounting protocol for applications such as network access or IP mobility intended for both local and roaming situations, Active Directory is Microsoft's trademarked directory service and an integral part of the Windows architecture, and NIS is a service that provides information to be known throughout a network.

The user information may be stored in a persistent store 212 associated with the Site Manager where the user account is created. The persistent store could be local to the Site Manager, in which case it is directly maintained by the Site Manager or external to the Site Manager, such as one associated with the NIS, Active Directory, Kerberos, or RADIUS. A user created in one site can have privileges for other sites as well. For example, a site administrator for a parent may have site administration privileges for all of its descendants.

In one example, there can be different user roles, such as site administrator, group administrator, and guest. Site administrators may be capable of performing all the operations in a site. Group administrators may be capable of managing only the resources assigned to their groups. For example, each department in an organization may be assigned a different group, and the storage devices belonging to a particular department may be considered to belong to the group for that department. Guests may generally have read-only management rights.

In addition to the capabilities defined by user roles, it may also be possible to limit the access permissions of each system administrator through access control lists on a per-object basis. In order to make this more manageable, it may also be possible to define groups of objects, and define access control lists for groups. Moreover, it may be possible to group administrator accounts together, and give them group-level permissions.

Alerts may be generated by different components including components 210, 220, 230, and 240 of the storage management module 200. Regardless of where they are generated, alerts are forwarded to the Site Manager 210 where they are persistently stored (until they are cleared by the system or by an administrator), in one example. The Site Manager 210 also notifies users and other management agents, such as SNMP or SMI-S, whenever a new alert at or above a certain criticality is generated. System administrators can set the notification criticality level, so that alerts at or above a certain criticality may be emailed to a set of administrator-defined email addresses. The users can also set other types of notifications and define other actions based on the alert type. Also, there may be a “call-home” feature whereby the Site Manager 210 notifies a storage vendor through an analog dial-up line if there are critical problems that require service.

In one embodiment, there is only one alert created per root cause. However, the same alert may be referenced by multiple objects if it impacts the health of all those objects. For example, when a storage device hosts two storage objects, one from a particular site and the other from another site, the failure of the storage device impacts both of these storage objects from different sites, and the alerts from the storage objects are generated by the storage management modules for both sites.

The Storage Resource Manager 220 provides storage virtualization for the storage devices 110 owned by a site based on storage requirements for applications of potentially different types, so that the storage devices in the site can be effectively used and managed for these applications. An application of one type has typically different storage requirements from that of another type. Storage requirements for an application can be described in terms of protection, performance, replication, and availability attributes. These attributes define implicitly how storage for these applications should be configured, in terms of disk layout and storage resource allocation for virtualized storage objects that implements the storage solution for these requirements.

In one example, Storage Resource Manager 220 includes policy management functions and uses a storage virtualization model to create, modify, and delete virtualized storage objects for client applications. It also determines and maintains a storage layout of these virtualized storage objects. Examples of storage layouts include different Redundant Array of Independent (or Inexpensive) Disks (RAID) levels, such as RAID0 for performance, RAID1 for redundancy and data protection, RAID10 for both performance and redundancy, RAID5 for high storage utilization with some redundancy, at the expense of decreased performance, etc. In one example, each site runs an active instance of the Storage Resource Manager 220 in a host 140 or node 120.

The Node Manager 230 is responsible for forming the site node for a site, which represents a cluster of all the nodes in the site. For that reason, the Node Manager 230 for a site 130 is sometimes referred to as the site node corresponding to the site 130. The Node Manager 230 may also handle storage network functions such as load balancing, high availability, and node fault management functions for the site. In one embodiment, the Node Manager 230 for a site 130 assigns node resources, such as CPU, memory, interfaces, and bandwidth, associated with the nodes 120 in the site 130, to the storage objects in the site 130, based on the Quality of Service (QoS) requirements of virtualized storage objects as specified by site administrators. In one example, nodes can have service profiles that may be configured to provide specific types of services such as block virtualization with iSCSI and file virtualization with NFS. Node service profiles are considered in assigning virtualized storage objects to nodes. An active instance of Node Manager 230 preferably runs on every physical node.

From the perspective of the Storage Resource Manager 220 at a site, the site includes a single node (with or without storage) and zero or more storage devices, and all storage services associated with the site are provided via this node. Specifically, the Storage Resource Manager 220 interacts with the site node that represents a cluster of all nodes in the site. In one example, the Node Manager 230 provides this single node image to the Storage Resource Manager 220, and the members of the cluster are hidden from the Storage Resource Manager 220.

Furthermore, the Node Manager 230 running on a physical node configures and monitors the Data Service Manager 240 on that particular node. The Data Service Manager 240, in one example, implements data service objects, which are software components that implements data service functions such as caching, block mapping, RAID algorithms, data order preservation, and any other storage data path functionality. The Data Service Manager 240 also provides virtualized data access to hosts/clients 140 through one or more links 242 using one or more data interfaces, such as iSCSI, FC, NFS, CIFS. It also configures and monitors storage devices 110 through at least one other 244 link using at least one management protocol and/or well-defined application programming interfaces (API) for managing storage devices locally attached to a particular node. Examples of management protocols for link 244 include but are not limited to SNMP, SMI-S, and/or any proprietary management protocols. An active instance of Data Service Manager 240 runs on every physical node.

The components 210, 220, 230, and 240 of the site software 200 may register with and utilize a Network Service Infrastructure 250 for addressing, naming, authentication, and time synchronization purposes. In one embodiment, the network service infrastructure 250 includes a Dynamic Host Configuration Protocol (DHCP) server (not shown), iSNS server (not shown), a Network Time Protocol (NTP) server (not shown), and/or a name server (not shown), such as a Domain Name System (DNS) or an Internet Storage Name Service (iSNS) server.

In order to reduce manual configuration, by default the physical nodes are configured through the DHCP server, which allows a network administrator to supervise and distribute IP addresses from a central point, and automatically sends a new address when a computer is plugged into a different place in the network. From the DHCP server, the physical nodes are expected to obtain not only their IP addresses, but also the location of the name server for the network 100.

A host 140 accessing the iSCSI data services provided by a site 130 may use the iSNS server to discover the location of the iSCSI targets. In the case of a failover that requires the IP address of an iSCSI target to change, the iSNS server may be used to determine the new location. The iSNS server may also be used for locating storage devices and internal targets in a site.

DNS Service Discovery (DNS-SD), which is an extension of the DNS protocol for registering and locating network services, may be used for registering NFS and CIFS data services. As an alternative, the Service Location Protocol (SLP) may also be used as the service discovery protocol for NFS and CIFS data services. SLP is an IETF standards track protocol that provides a framework to allow networking applications to discover the existence, location and configuration of networked services in enterprise networks.

In one embodiment, each site 130 supports one or more commonly used authentication services, such as NIS, Active Directory, Kerberos, or RADIUS. The commonly used authentication services may be used to authenticate users and control their access to various network services.

In order to address time synchronization requirements, site entities may synchronize their real time clocks by means of the NTP server, which is commonly used to synchronize time between computers on the Internet, for the purposes of executing scheduled tasks, and time stamping event logs, alerts, and metadata updates.

In one embodiment, network 100 may comprise one or more sub-networks (subnet). A subnet may be a physically independent portion of a network that shares a common address component. A site may span multiple subnets, or multiple sites may be included in the same subnet. In order to provide for subnet-independent access to management services, dynamic DNS may be used to determine the location of the Site Manager 210. Alternatively, all physical instances of a Site Manager 210 could be placed on a same subnet, and conventional IP takeover techniques could be used to deal with a Site Manager failover. However, this alternative is not a preferred solution, particularly in the case of a network having multiple sites.

In order to manage multiple sites under a same management entity, sites may be hierarchically organized in a tree form with an arbitrary number of levels. Further, a site can include another site as an element or constituent. That is, a site can be a collection of nodes, storage devices, and other sites. This creates a parent-child relationship between sites. As shown in FIG. 1, if a site, such as site U, is included in another site, such as site W, site U is a child of site W and site W is the parent of site U. A parent site may have multiple child sites, but a child site has only one parent site, as sites are hierarchically organized in a tree form. A parent site may also have another site as its parent. Thus, the site hierarchy may include an arbitrary number of levels with a child site being a descendent of not only its parent site but also the parent of its parent site. In the example shown in FIG. 1, site W as the parent site of sites U and V includes two virtual nodes corresponding to site U and site V. Preferably, all of the storage resources in a parent site can be assigned to the child sites, so that a parent site owns only virtual nodes with storage and does not own any storage devices. Therefore, in one embodiment, a parent site never owns physical resources, and physical resources are included only in sites that are at the leaves of the tree representing the site hierarchy. The sites at the leaves of the tree are sometimes referred to herein as leaf sites.

In one exemplary application of the site hierarchy, the leaf sites correspond to the physical storage sites or sections of physical storage sites of an enterprise or organization, while the parent sites are non-leaf sites that correspond to a collection of their child sites. As an example, each physical storage site has a network of at least one storage controller and at least one storage device.

In one example, the hosts or clients 140 which connect to a parent site to access a storage service (e.g., an iSCSI volume, or an NFS file system) discover the parent site's contact address through the Network Services Infrastructure 250, and connect to that contact address. The contact address resides in a physical node in a leaf site, and it could be migrated to other nodes or other leaf sites as needed due to performance or availability reasons. The hosts or clients 140 do not need to be aware of which physical node is providing the site access point.

Note that each site in a site hierarchy is assumed to have a unique name. If two site hierarchies are to be merged, it should first be ensured that the two site hierarchies do not have any sites with the same name.

For the system administrators, the name resolution may be hierarchical. In other words, a system administrator account may be created on a specific site, and referred to relative to that site's name in the hierarchy. In one exemplary embodiment, the privileges of a system administrator on a parent site are applicable by default to all of its child sites, and so forth.

In one embodiment, a parent site can be created for one or more existing child sites. Creation of a parent site is optional and can be used if there are multiple sites to be managed under a single management and/or viewed as a single site. A site administrator may configure a site as a parent site by specifying one or more existing sites as child sites. Since, in one example, a site can have only one parent site, the sites to be specified as child sites must be orphans, meaning that they are not child sites of other parent site(s). Additionally, a child and its parent have to authenticate each other to establish this parent-child relationship. This authentication may take place each time the communication between a parent and a child is reestablished. The site administrator of a child or parent site may be allowed to tear down an existing parent-child relationship. When a site becomes a child of a parent site, the site node for the child site joins the parent site as a virtual node.

In one embodiment, the Site Manager 210 for each site in the site hierarchy is responsible for forming, joining, and maintaining the site hierarchy. When a system administrator issues a command to create a site in a site hierarchy, the site's identity and its place in the site hierarchy are stored in the persistent store of the Site Manager for that site. Therefore, each Site Manager knows the identity of its parent and child sites, if it has any. When a Site Manager 210 for a child site is first started up, if the site has a parent site, the Site Manger 210 discovers the physical location of its parent site using the Network Service Infrastructure 250, and establishes communication with the Site Manager of its parent using a management protocol such as SNMP or SMI-S. Similarly, the Site Manager 210 of a parent site determines the physical location of their children sites using the Network Service Infrastructure 250 and establishes communication with them.

Each component 210, 220, 230, and 240 in the storage management module 200 has a different view of the site hierarchy, and some components in the site software program 200 do not even need to be aware of any such hierarchy. For example, the Data Service Manager 240 does not need to be aware of the site concept, and may be included only in leaf sites. From the perspective of a Node Manager 230 for a parent site, a child site is viewed as a virtual node with storage; and from the perspective of the Storage Resource Manager 220 for a parent site, a child site is viewed as a storage device of the parent site. Therefore, the storage virtualization model used by the Storage Resource Manager 220 for a parent site is the same as that for a leaf site, except that the Storage Resource Manager 220 for a parent site only deals with one type of storage device—one that corresponds to a child site. The Storage Resource Manager 220 of a site does not need to know or interact with the Storage Resource Manager 220 of another site, whether the other site is its parent site or its child site.

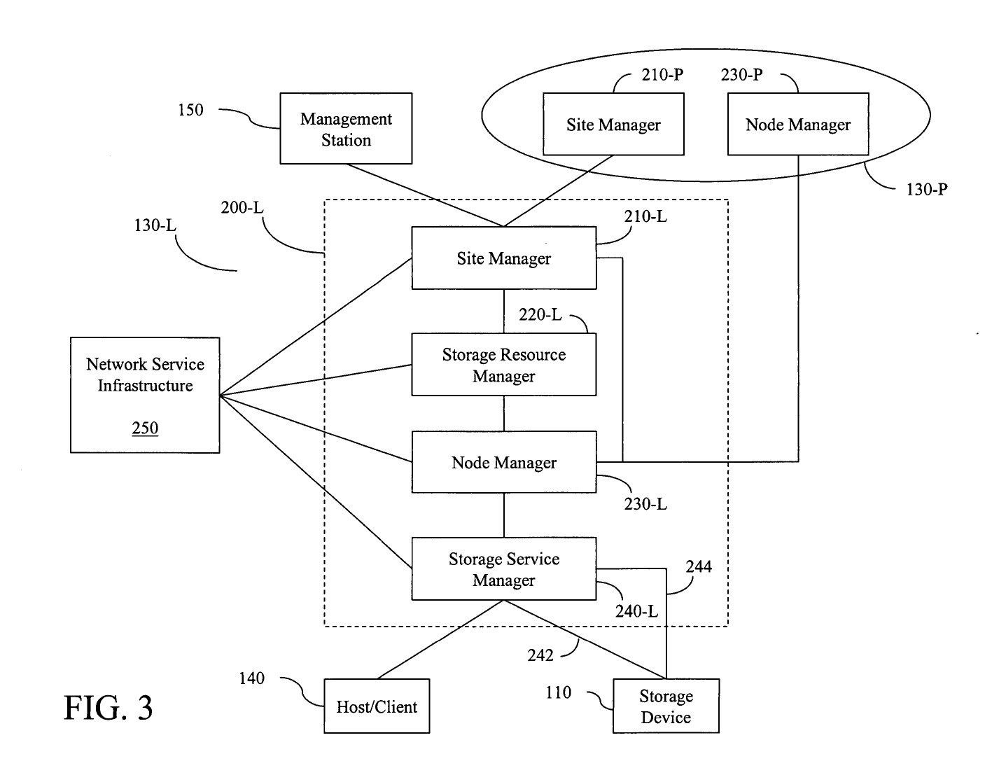

Since the parent sites do not have any physical entities, and instead rely on the physical entities of the leaf sites, the storage management module 200 for a leaf site can be structured differently from the storage management module 200 for a parent site. FIG. 3 illustrates the architecture of the storage management module 200-L for a leaf site 130-L, which has a parent site 130-P. Storage management module 200-L is shown to comprise a Site Manager 210-L, a Storage Resource Manager 220-L, a Node Manager 230-L, and a Data Service Manager 240-L. The Site Manager 210-L communicates with a Site Manager 210-P of the parent site 130-P using one or more external interfaces, such as, the SNMP protocol. The node manager 230-L may communicate directly with a node manager 230-P of the parent site 130-P. The data service manager 240-L communicates with the clients 140, other sites 130, and storage devices 110 using storage access protocols, such as iSCSI, FC, NFS, and CIFS. The data service manager 240-L may also communicate with the storage devices 210 using storage device management protocols, such as SNMP, and SMI-S.

A storage service request directed to a site is served by accessing the storage resources in the site. Referring to FIG. 3, storage resources, such as virtualized storage objects associated with the storage devices 110, in the leaf site 130-L by default is owned by the leaf site 130-L, meaning that the leaf site has control and management of the storage resources. The parent site 130-P does not have its own physical resources such as storage devices and physical nodes. However, site administrators for a leaf site 130-L have an option of exporting some of the virtualized storage objects and free storage resources owned by the leaf site to the parent site 130-P of the leaf site. In one embodiment, the leaf site 130-L relinquishes the control and management of the storage resources exported to its parent, so that the exported objects can be accessed and managed only by the parent site 130-P.

The export operation is initiated by a site administrator who has privileges for the leaf site 130-L. The site administrator first requests the Storage Resource Manager component 220-L of the Storage management module 200-L for the leaf site to release the ownership of the exported object. It then contacts the Site Manager 210-P of the parent site 130-P using the site management interface to inform the parent site 130-P about the exported object. The Storage Resource Manager 220-L of the leaf site 130-L contacts its site node 230-L about the ownership change for this particular object. In turn, the site node 230-L propagates this change to the associated leaf nodes so that it can be recorded on persistent stores associated with the exported the objects.

Alternatives to the export approach discussed above include use of Access Control Lists to give permissions to administrators of the parent site to use some of the resources owned by its child sites.

A parent site's Site Manager may also connect to and manage its child sites through the Site Manager's external interfaces. This allows administrators to manage multiple child sites from a single parent by relaying commands entered at the parent site to a child site.

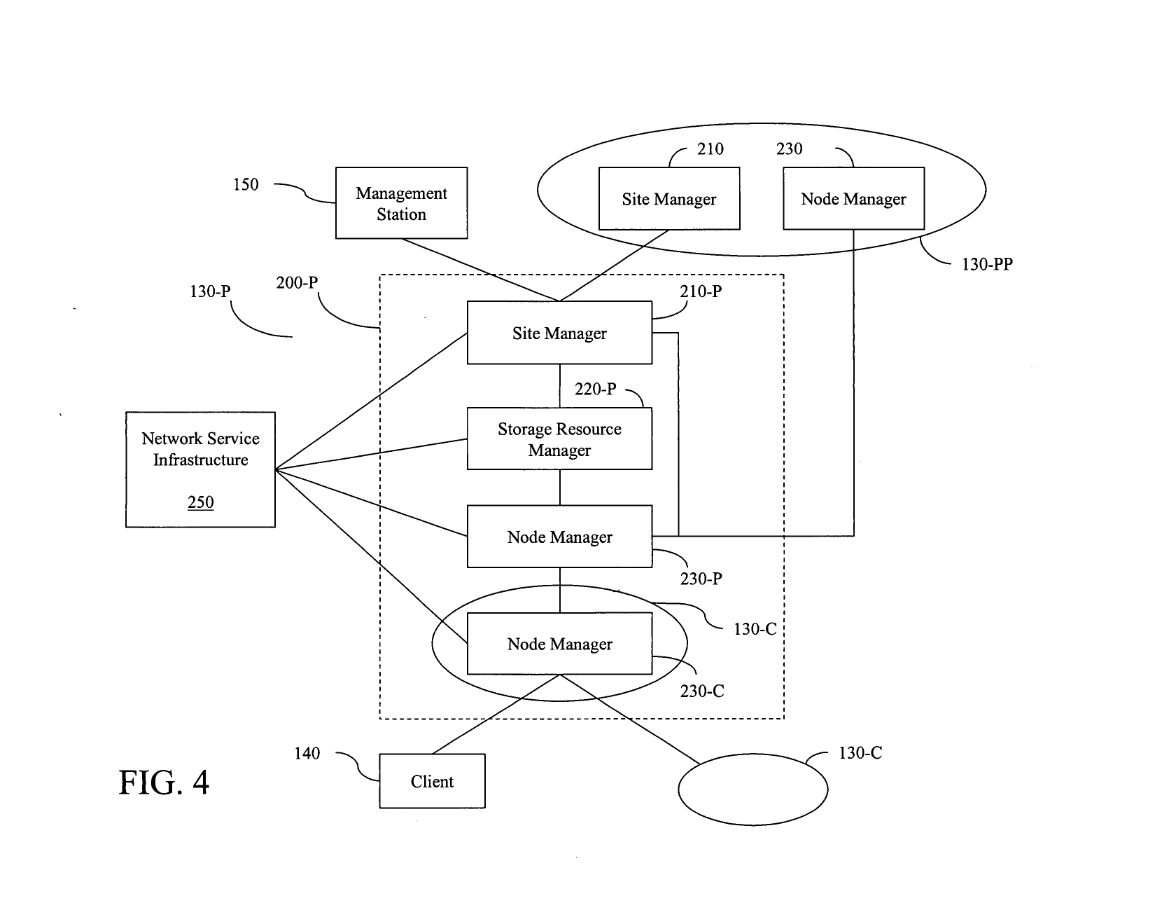

FIG. 4 illustrates the architecture of a storage management module 200-P for the parent site 130-P, which has one or more child sites 130-C and possibly a parent site 130-PP. As shown in FIG. 4, the site management agent 200-P for the parent site comprises a site manager 210-P, a storage resource manager 220-P, and a node manager 230-P. The site manager 210-P communicates with the management station 150 coupled to the parent site 130-P, and with site manager 210 of its parent site 130-PP, if there is any, using a management protocol, such as SNMP or SMI-S. The node manager 230-P communicates with the node manager 230 of the parent site 230-PP, and the node manager(s) 230-C of the one or more child sites 130-C. Each child site 130-C may or may not be a leaf site.

Unlike the storage management module for a leaf site, the storage management module 200-P for the parent site 130-P does not need to include its own Data Service Manager component, because the parent site does not have any physical resources. The Node Manager component 230-P of the parent site 130-P provides a virtual node representing a cluster of all of the site nodes corresponding to the child sites 130-C. The parent site's node manager 230-P also configures and communicates with the node manager(s) 230-C of the child site(s) 130-C by assigning storage resources in the parent site to the site nodes corresponding to the child sites. The node manager(s) 230-C of the child site(s) 130C in turn configure and assign the storage resources to the nodes belonging to the child site(s) 130-C. This continues if the child site(s) 130-C happen to be the parent(s) of other site(s), until eventually the storage resources in the parent site 130-P are assigned to one or more of the leaf nodes in one or more leaf sites.

The Site Manager 210 in each site management agent 200 is the component primarily responsible for the management of a geographically distributed site. In one embodiment, the Site Manager 210 for each site 130 is run with high availability. The high availability of the Site Manager 210 is achieved by running an active instance of the Site Manager 210 for each site and configuring one or more standby instances for each active instance of the Site Manager 210. In one embodiment, a site 130 is considered not available for management if neither an active Site Manager instance and nor a standby Site Manager instance is available. However, services provided by the data service manager 240, node manager 230, and storage resource manager 210 for the site may continue to be available even when the site is not available for management. In other words, the data and control paths associated with storage resources in a site will not be affected or degraded because of Site Manager failures.

In one embodiment of the present invention, the persistent store of the active instance of the Site Manager 210 is replicated by the standby instance of the Site Manager using known mirroring techniques. The standby instance of the Site Manager uses keep-alive messages to detect any failure of the active instance, and when a failure is detected, the standby instance of the Site Manager switches to an active mode and retrieves from its copy of the persistent store the state of the failed active instance of the Site Manager.

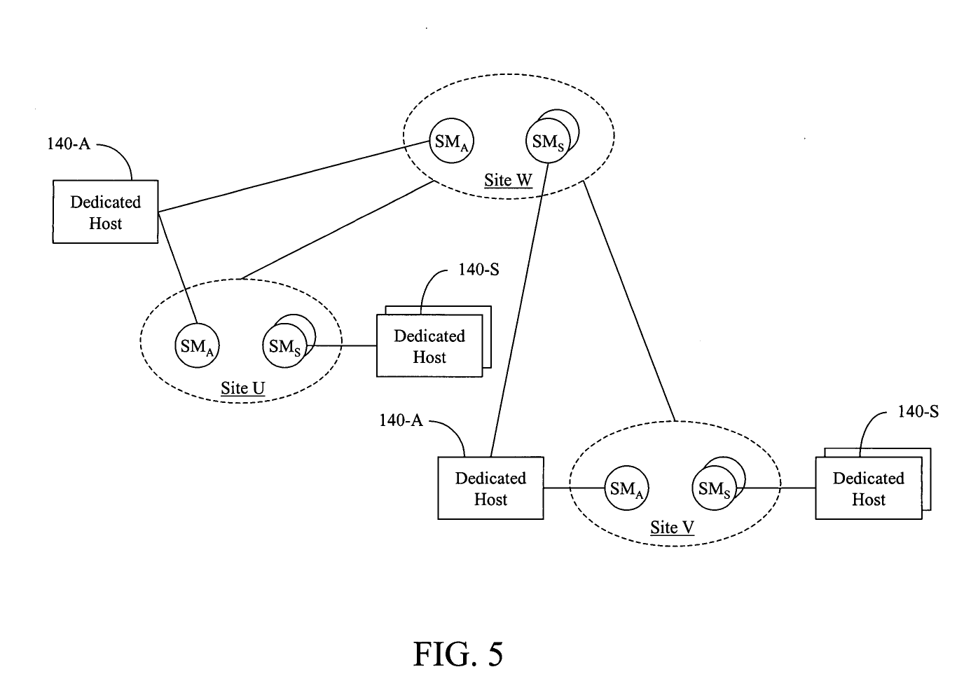

The instances of the Site Manager 210 for a site 130 can run on dedicated hosts 140 located anywhere in the network 100, or on nodes 120 in the site 130. FIG. 5 illustrates a situation where the Site Manager instances run on dedicated hosts 140, with SM_{A} and SM_{S} representing the active and standby Site Manager instances, respectively. For each site shown in FIG. 5, a dedicated host 140-A runs an active instance of the Site Manger 210, and at least one dedicated host 140-S runs at least one standby instance of the Site Manager 210. Some or all of the active Site Manager instances SM_{A} may physically run on the same host 140-A, and some or all of the standby Site Manager instances SM_{S} may physically run on the same host 140-S. In one embodiment, Site Manager instances for different sites, whether they are active or standby, can run on a same host. As shown in FIG. 5, when a site administrator for site U decides to create a parent site, such as site W, for both site U and site V, the SM_{A} for site U creates an active instance SM_{A} for the Site Manager of site W preferably on the same host the SM_{A} for site U is running, and specifies that site W is the parent of site U. To add site V as the child of site W, the SM_{A} of site V creates a standby instance SM_{S} for the Site Manager of site W preferably on the same host the SM_{A} of site V is running. A two level site hierarchy is thus formed.

For a leaf site, the physical locations of the dedicated hosts 140 where the Site Manger instances run are independent of the physical locations of the leaf site, meaning that the dedicated hosts 140 may or may not be at the same physical location as the leaf site. Similarly, for a parent site, such as site W, the physical locations of the dedicated hosts 140 where the Site Manger instances run are independent of the physical locations of the child sites, such as site U and site V, meaning that the dedicated hosts 140 may or may not be at the same physical locations as the child sites. As illustrated in FIG. 5, an active Site Manager instance SM_{A} may have more than one corresponding standby Site Manager instances SM_{S}.

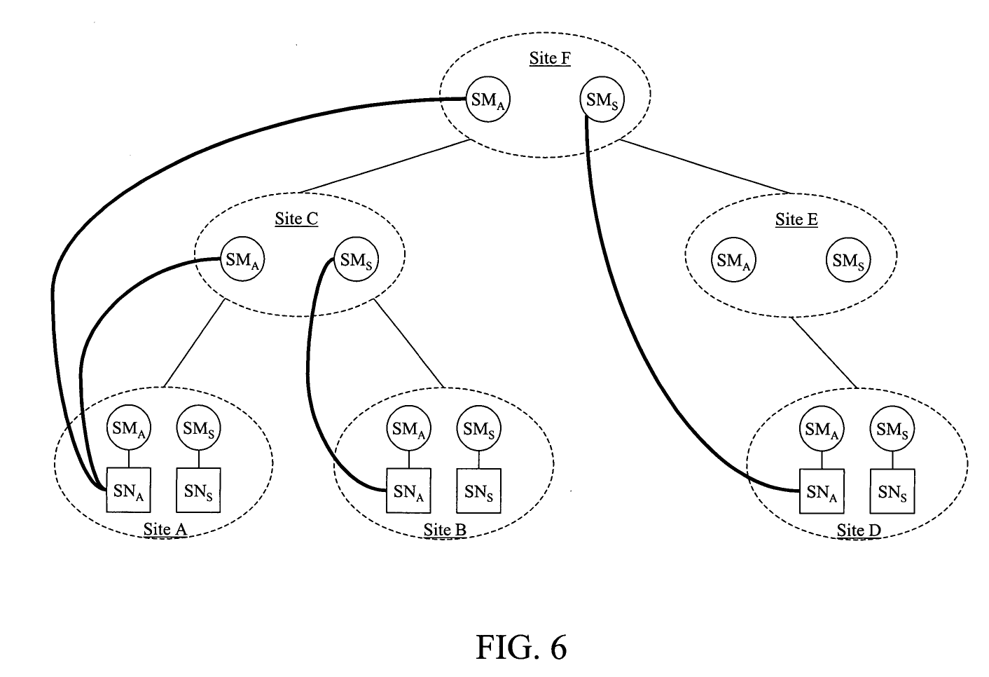

FIG. 6 illustrates a situation where SM instances run on nodes 120. In this configuration, in one example, it is the responsibility of the site node 230 corresponding to a site 130 to decide which physical node 120 in the site should be chosen to run the active or standby SM instance. As shown in FIG. 6, assuming a parent site, such as site C, is to be created for two leaf sites, such as site A and site B, the Site Manager of site A requests its site node SN_{A} to create a Site Manager instance SM_{A} for the parent site on one of its leaf nodes. With the active Site Manager instance for site C created on site A, the site node for site C is also created on site A. To add site B as the second child of the parent site C, another Site Manager instance SM_{S} for site C is created on a leaf node of site B by the site node SN_{A} of site B. This other instance SM_{S} becomes a standby instance of the Site Manager for site C.

Similarly, assuming a parent site, such as site F, is to be created for two other parent sites, such as site C and site E, the Site Manager of a leaf site that is a descendant of site C, such as site A, requests its site node SN_{A} to create a Site Manager instance SM_{A} for site F on one of its leaf nodes, which may or may not be the same leaf node the SM_{A} for site A is running. With the active Site Manager instance for site F created on site A, the site node for site F is also created on site A. To add site E as the second child of site F, another Site Manager instance SM_{S} for site F is created in a leaf site that is a descendant of site E, such as site D, by the site node SN_{A} of site D. This other instance SM_{S} becomes a standby instance of the Site Manager for site C.

Note that it is permissible to mix the two types of deployment of Site Manager instances, as discussed above in reference to FIGS. 5 and 6, for different sites if desired. Also, the instances for Storage Resource Manager 220 may be deployed similarly as the Site Manager instances.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

While the invention has been particularly shown and described with reference to embodiments thereof, it will be understood by those skilled in the art that various other changes in the form and details may be made without departing from the spirit and scope of the invention.

We claim:

1. A system for managing a distributed storage, comprising:
a first site including a network having nodes and storage devices; and
a first management module running on the network for managing the first site and including a site manager, a storage resource manager, a node manager, and a data service manager, the site manager providing a management entry point and persistently storing information associated with the first site and information associated with users of the first site, the storage resource manager providing storage virtualization for the storage devices, the node manager forming a site node representing a cluster of the nodes in the first site so that the storage resource manager interacts with the site node to provide storage virtualization and so that the nodes in the first site are hidden from the storage resource manager, the data service manager implementing data service objects and providing virtualized data access to users of the network of nodes and storage devices.

2. The system of claim 1 wherein the first site manager provides authentication to access the first site and access control rights for storage resources associated with the storage devices.

3. The system of claim 1 wherein the storage resource manager creates, modifies, and deletes virtualized storage objects for client applications of different types.

4. The system of claim 3 wherein the storage resource manager maintains a storage layout of the virtualized storage objects.

5. The system of claim 3 wherein the node manager assigns the virtualized storage objects to the nodes in the first site.

6. The system of claim 1 wherein all storage services associated with the first site are provided via the site node.

7. The system of claim 1 wherein the node manager configures and monitors the data service manager.

8. The system of claim 1 wherein the data service manager configures and monitors the storage devices.

9. The system of claim 1 wherein the management module integrates with a network service infrastructure for addressing, naming, authenticating, and time synchronizing purposes, the network service infrastructure including at least one of a DHCP server, an iSNS server, a NTP server, and a DNS server.

10. The system of claim 9 wherein the nodes include at least one physical node representing a storage controller, each of the at least one physical node being configured through the DHCP server.

11. The system of claim 1, further comprising:
a plurality of sites organized in a tree form, the plurality of sites including the first site and a second site having a plurality of virtual nodes including a first virtual node corresponding to the first site; and
a second management module for managing the second site and including a site manager, a storage resource manager, and a node manager.

12. The system of claim 11 wherein the plurality of sites further includes a third side and the plurality of virtual nodes further include a second virtual node corresponding to the third site, and wherein the node manager of the second management module configures the plurality of virtual nodes by assigning storage devices in the second site to the plurality of virtual nodes.

13. The system of claim 11 wherein the nodes in the first site include a physical node and the second site has a contact address residing in the physical node.

14. The system of claim 13 wherein the physical node provides a site access point for accessing the second site.

15. The system of claim 11 wherein the site manager of the first management module and the site manager of the second management module communicate with each other using a management protocol.

16. The system of claim 11 wherein the node manager of the first management module communicates directly with the node manager of the second management module.

17. The system of claim 12 wherein the node manager of the second management module forms a site node representing a cluster of the nodes in the second site.

18. The system of claim 17 wherein the storage resource manager of the second management module regards the first site as a storage device associated with the site node.

19. The system of claim 11 wherein the second site does not have any storage devices not belonging to any of the virtual nodes.

20. The system of claim 11 wherein the site manager of the second management module includes an active instance and at least one standby instance.

21. The system of claim 20 wherein each of the active and standby instances include a persistent store for storing user and site level information, and wherein the persistent store of the active instance is replicated by the persistent store of the standby instance.

22. The system of claim 20 wherein the at least one standby instance detects failure of the active instance using keep-alive messages.

23. The system of claim 11 wherein the site manager of the second management module includes an active instance that runs on a dedicated host.

24. The system of claim 23 wherein the site manager of the second management module includes at least one standby instance that runs on at least one dedicated host.

25. The system of claim 11 wherein the nodes in the first site includes a first physical node, and the site manager of the second management module includes an active instance that runs on the first physical node.

26. The system of claim 25 wherein the plurality of sites further includes a third site having a second physical node and the plurality of virtual nodes further include a second virtual node corresponding to the third site, and wherein the site manager of the second management module includes at least one standby instance that runs on the second physical node.

27. The system of claim 1 wherein the storage devices are heterogeneous in their access protocols and physical interfaces.

28. The system of claim 27 wherein the access protocols includes at least two of Fibre Channel, Internet Protocol (IP), iSCSI (internet-SCSI), Network File System (NFS), and Common Internet File System (CIFS).

29. The system of claim 1 wherein the nodes and storage devices have similar geographical distance properties.

30. The system of claim 1 wherein the data service manager provides virtualized data access to hosts/clients coupled to the network of nodes and storage devices, through data interfaces that include at least one of the group consisting of iSCSI, FC, NFS, and CIFS.

31. A storage management system, comprising:
a plurality of sites including first, second, and third sites, the first and second site each having a network of controller nodes and storage devices;
a first management module associated with the first site and configured to form a first virtual node corresponding to the first site and representing a cluster of the controller nodes in the first site, and configured to provide storage services associated with the first site through the first virtual node;
a second management module associated with the second site and configured to form a second virtual node corresponding to the second site and representing a cluster of the controller nodes in the second site, and configured to provide storage services associated with the second site through the second virtual node; and
a third management module associated with the third site configured to form a site node corresponding to the third site and representing a cluster of a plurality of virtual nodes including the first and second virtual nodes.

32. A method for managing a geographically distributed storage having a plurality of controller nodes and a plurality of storage devices, comprising:
forming a hierarchy of sites including a plurality of management sites each being assigned a portion of the plurality of controller nodes and a portion of the plurality of the storage devices, and including at least a first parent site having at least a first portion of the plurality of management sites as child sites;
forming a virtual node for each of the management site to represent a cluster of the controller nodes in the management site such that the first parent site includes virtual nodes corresponding to the child sites; and
forming a first site node for the first parent site to represent a cluster of the nodes in the first parent site; and

33. The method of claim 32, further comprising:
running an active instance of a site manager for each management site; and
running an active instance of a site manager for the first parent site.

34. The method of claim 33 wherein the active instance of the site manager for the first parent site is run on a controller node in one of the first portion of the plurality of management sites.

35. The method of claim 32 wherein the hierarchy of sites further includes a second parent site having a second portion of the plurality of management sites as child sites and including virtual nodes corresponding to the second portion of the plurality of management sites, and further includes a third parent site having the first and second parent sites as child sites, the method further comprising:
forming a second site node for the second parent site to represent a cluster of the nodes in the second parent site;
forming a third site node for the third parent site to represent a cluster of nodes including the first site node and the second site node; and
processing storage service requests associated with the first and second portion of the management sites through the third site node.

36. The method of claim 35, further comprising running an active instance of a site manager for the second parent site on a controller node in one of the first and second portions of the plurality of management sites.

37. The method of claim 32 wherein the plurality of management sites include first and second management sites, and the step of forming a hierarchy of sites including creating an active instance of a site manager for the first parent site at the first management site and creating a standby instance of the site manager at the second management site.

38. The method of claim 37 wherein the plurality of management sites further include a third management site, and the hierarchy of sites further include a second parent site having the third management site as a child site, and a third parent site having the first and second parent sites as child sites, and wherein the step of forming a hierarchy of sites further includes creating an active instance of a site manager for the third parent site at one of the first, second, and third management site, and further includes creating a standby instance of the site manager for the third parent site at another one of the first, second, and third management site.
